(19) United States
(12) Patent Application Publication
(10) Pub. No.: US 2005/0225253 A1
(43) Pub. Date: Oct. 13, 2005

(54) Display device and manufacturing method of the same

(75) Inventors: Tsutomu Yamada, Mizuho-shi (JP); Kazuhiro Imao, Gifu-shi (JP)

Correspondence Address: Barry E. Bretschneider;Morrison & Foerster LLP, Suite 300, 1650 Tysons Boulevard, McLean, VA, 22102, US

(73) Assignee: Sanyo Electric Co., Ltd., Moriguchi-city (JP)

(21) Appl. No.: 11/100,613

(22) Filed: Apr. 7, 2005

(30) Foreign Application Priority Data
Apr. 9, 2004 (JP) 2004-114851

(51) Int. Cl. G09G 3/10

(52) U.S. Cl. 315/169.3; 315/169.2

(57) ABSTRACT

The invention is directed to reduction of a pattern size of a driving transistor of an emissive element and an improvement of an aperture ratio of a pixel. A second active layer of a driving TFT is formed of a two laminated polysilicon layers. The upper polysilicon layer is formed at the same time when a polysilicon layer forming a first active layer of a pixel selecting TFT is formed, and has a same thickness as that of the first active layer. Therefore, the second active layer is formed thicker by a film thickness of the lower polysilicon layer. An average crystal grain size of the second active layer is smaller than an average crystal grain size of the first active layer. Therefore, a carrier mobility of the driving TFT is lower than a carrier mobility of the pixel selecting TFT. This can shorten a channel length of the driving TFT.

### CROSS-REFERENCE OF THE INVENTION

This invention is based on Japanese Patent Application No. 2004-11485, the content of which is incorporated by reference in its entirety.

### BACKGROUND OF THE INVENTION

1. Field of the Invention

This invention relates to a display device and a manufacturing method thereof, particularly to a display device of which each of pixels has an emissive element emitting light by receiving a current supply, a pixel selecting transistor for selecting a pixel in response to a gate signal, and a driving transistor for supplying a current to the emissive element in response to a display signal supplied through the pixel selecting transistor, and a manufacturing method thereof.

2. Description of the Related Art

Organic electroluminescent (referred to as EL hereinafter) display devices with an organic EL element have been gathering attention as a display device substituting a CRT or an LCD. The development efforts for the organic EL display device with a thin film transistor (referred to as TFT hereinafter) as a switching element for driving the organic EL element have been made accordingly.

FIG. 8 is an equivalent circuit diagram of a pixel of an EL display device. In an actual organic EL display panel, a plurality of pixels is formed in a matrix of n rows and m columns.

A gate signal line 50 supplying a gate signal Gn and a drain signal line 60 supplying a display signal Dm are crossing each other. An organic EL element 70, a driving TFT 80 driving the organic EL element 70, and a pixel selecting TFT 10 selecting a pixel are disposed near a crossing of these signal lines.

A source of the driving TFT 80 is supplied with a positive power supply voltage PVdd from a power supply line 90, and a drain of the driving TFT 80 is connected with an anode 71 of the organic EL element 70.

A gate of the pixel selecting TFT 10 is connected with the gate signal line 50 and supplied with the gate signal Gn therefrom. A drain 10d of the pixel selecting TFT 10 is connected with the drain signal line 60 and supplied with the display signal Dm therefrom. A source 10s of the pixel selecting TFT 10 is connected with a gate of the driving TFT 80. The gate signal Gn is outputted from a vertical driver circuit (not shown). The display signal Dm is outputted from a horizontal driver circuit (not shown).

The organic EL element 70 is formed of an anode 71, a cathode 72, and an emissive layer (not shown) formed between the anode 71 and the cathode 72. The cathode 72 is supplied with a negative power supply voltage CV. The gate of the driving TFT 80 is connected with a capacitor Cs. The capacitor Cs is provided for retaining the display signal of the pixel for one field period by retaining a charge corresponding to the display signal Dm.

An operation of the EL display device having the above structure will be described. When the gate signal Gn turns to high level for one horizontal period, the pixel selecting TFT 10 turns on. The display signal Dm is applied from the drain signal line 60 to the gate of the driving TFT 80 through the pixel selecting TFT 10 and also retained by the capacitior Cs.

Conductance of the driving TFT 80 changes in response to the display signal Dm supplied to the gate thereof, and a drive current corresponding to the conductance is supplied to the organic EL element 70 through the driving TFT 80, thereby activating the organic EL element 70. A drive current does not flow in the driving TFT 80 when the driving TFT 80 turns off in response to the display signal Dm supplied to the gate, thereby turning the light emission of the organic EL element 70 off. The relevant technology is described in Japanese Patent Application Publication No. 2002-175029.

However, the pixel selecting TFT 10 need be switched at high speed in response to the gate signal Gn, while the driving TFT 80 does not need the high speed switching, and rather has an adverse influence on a grayscale image if it has the same structure as the pixel selecting TFT 10. That is, the grayscale image of the organic EL display device is displayed by a control of an electric current by the driving TFT 80, but the control of the amount of the electric current becomes difficult if the driving TFT 80 has a high current drive performance.

For minimizing the current drive performance of the driving TFT 80, a channel length of the driving TFT 80 must be long. However, such a structure increases a pattern size of the driving TFT 80. Since a region of the driving TFT 80 does not transmit light, an aperture ratio of a pixel (a ratio of an effective emissive area to all the area of the pixel) reduces by an increasing amount of the pattern size.

### SUMMARY OF THE INVENTION

The invention provides a display device that includes a plurality of pixels, an emissive element provided in each of the pixels and emitting light by receiving a current, and a pixel selecting transistor provided in each of the pixels and selecting a corresponding pixel in response to a gate signal. The pixel selecting transistor includes a first active semiconductor layer, a first gate insulating layer formed on the first active semiconductor layer and a first gate electrode formed on the first gate insulating layer. The device also includes a driving transistor provided in each of the pixels and supplying the current to a corresponding emissive element in response to a display signal supplied through a corresponding pixel selecting transistor. The driving transistor includes a second active semiconductor layer, a second gate insulating layer formed on the second active semiconductor layer and a second gate electrode formed on the second gate insulating layer. The film thickness of the first active semiconductor layer is different from the film thickness of the second active semiconductor layer, and an average crystal grain size of the first active semiconductor layer is larger than an average crystal grain size of the second active semiconductor layer.

The invention also provides a method of manufacturing a display device. The method includes forming a first amorphous silicon layer in a first region of an insulating substrate, forming a second amorphous silicon layer in a second region of an insulating substrate so as to have a thickness different from the thickness of the first amorphous silicon layer, irradiating the first and second amorphous silicon layers with laser of a predetermined energy density so as to crystallize the first and second amorphous silicon layers, forming a pixel selection transistor in the first region so that part of the first amorphous silicon layer forms an active layer of the pixel selection transistor, and forming a transistor driving the emissive element in the second region so that part of the second amorphous silicon layer forms an active layer of the driving transistor. The energy density of the laser is set so that an average crystal grain size of the first active layer is larger than an average crystal grain size of the second active layer.

### BRIEF DESCRIPTION OF THE DRAWINGS

FIG. 1 is a plan pattern view of a pixel of an organic EL display device of an embodiment of the invention.

FIGS. 2A and 2B are cross-sectional views explaining a manufacturing method of the organic EL display device of the embodiment of the invention.

FIGS. 3A and 3B are cross-sectional views explaining the manufacturing method of the organic EL display device of the embodiment of the invention.

FIGS. 4A and 4B are cross-sectional views explaining the other manufacturing method of the organic EL display device of the embodiment of the invention.

FIGS. 5A and 5B are cross-sectional views explaining the other manufacturing method of the organic EL display device of the embodiment of the invention.

FIG. 6 is a diagram showing a result of an experiment about a relation between an average crystal grain size of silicon and a laser energy density.

FIG. 7 is a schematic diagram showing a relation between an average crystal grain size of silicon and a laser energy density.

FIG. 8 is an equivalent circuit diagram of a pixel of an organic EL display device of a conventional art.

### DETAILED DESCRIPTION OF THE INVENTION

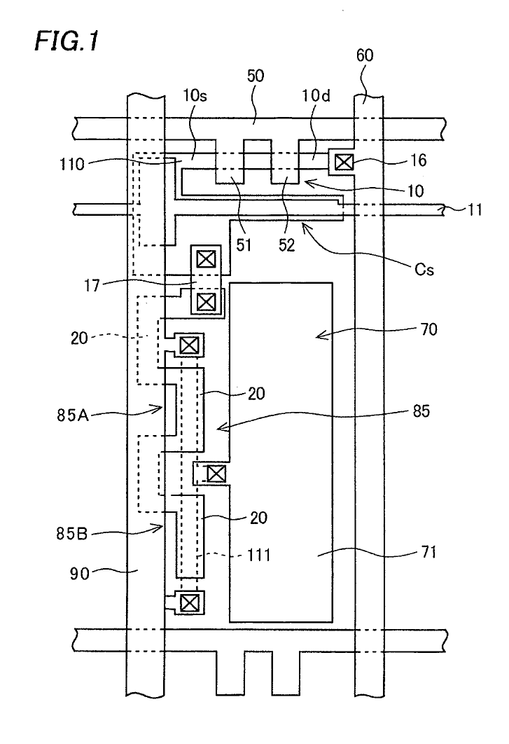

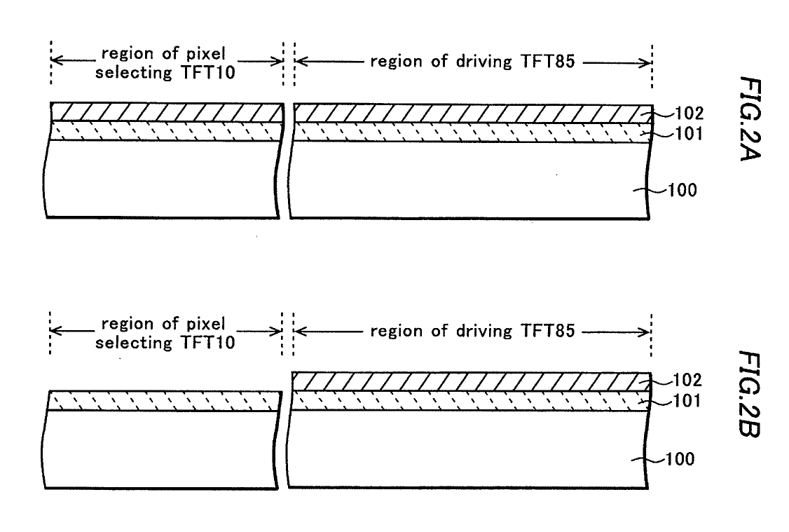

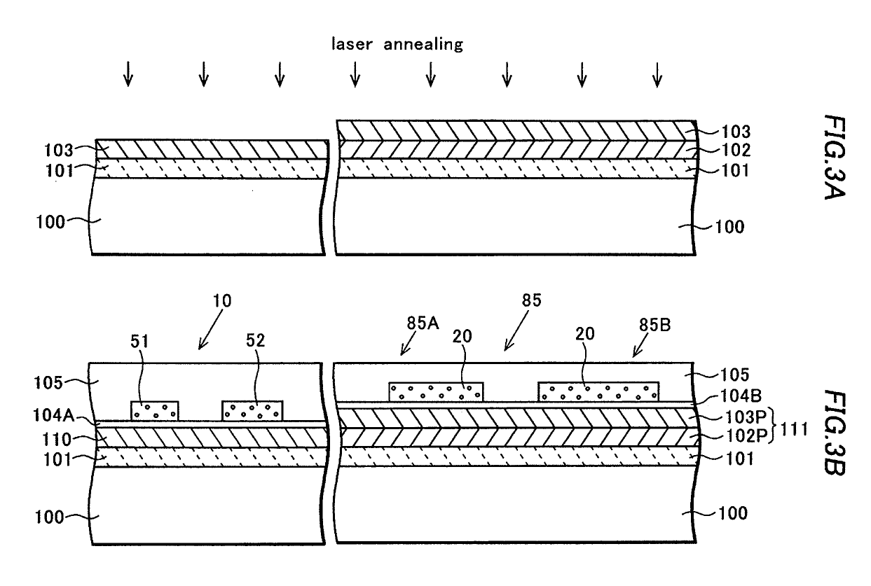

An embodiment of the invention will be described in detail with reference to drawings. FIG. 1 is a plan pattern view of a pixel of an organic EL display device. In an actual organic EL display panel, a plurality of the pixels is disposed in a matrix of n rows and m columns. FIGS. 2A, 2B, 3A, and 3B are cross-sectional views showing structures of a pixel selecting TFT 10 and a driving TFT 85 and a manufacturing method thereof. It is noted that an equivalent circuit diagram of a pixel of this organic EL display device is the same as that shown in FIG. 8.

A pixel structure of the organic EL display device of the invention will be described in detail. As shown in FIG. 1, a gate signal line 50 supplying a gate signal Gn extends in a row direction, and a drain signal line 60 supplying a display signal Dm extends in a column direction. These signal lines cross each other three-dimensionally. The gate signal line 50 is formed of a chromium layer or a molybdenum layer, and the drain signal line 60 is formed of an aluminum layer formed on the gate signal line 50.

The pixel selecting TFT 10 has a double gate structure forming two gate electrodes 51 and 52 extending from the gate signal line 50 on a first gate insulating layer 104A formed on a first active layer 110 of a polysilicon layer which is formed on a transparent insulating substrate 100 of a glass substrate with a buffer layer 101 therebetween.

A drain 10d of the pixel selecting TFT 10 is connected with the drain signal line 60 through a contact 16. A polysilicon layer forming a drain 10s of the pixel selecting TFT 10 extends in a capacitor region, overlapping the capacitor line 11 formed thereon with a capacitor insulating film therebetween, so that a capacitor Cs is formed at this overlapping portion. The polysilicon layer extending from the drain 10s of the pixel selecting TFT 10 is connected with a gate electrode 20 of the driving TFT 85 through an aluminum wiring 17.

In this driving TFT 85, a second gate insulating layer 104B is formed on a second active layer 111 formed on the transparent insulating substrate 100 of a glass substrate with a buffer layer 101 therebetween, and a gate electrode 20 formed of a chromium layer or a molybdenum layer is formed on the second gate insulating layer 104. The driving TFT 85 includes two parallel transistors 85A and 85B with a common gate electrode 20. A common source of the parallel transistors 85A and 85B is connected with a power supply line 90 supplied with a positive power supply voltage PVdd through a contact. A common drain of the parallel transistors 85A and 85B is connected with an anode 71 of an organic EL element 70 through a contact. The second gate insulating layer 104B is formed under the gate electrode 20.

The second active layer 111 has a two-layered structure of polysilicon layers 102P and 103P. The upper polysilicon layer 103P is formed at the same time when the polysilicon layer forming the first active layer 110 is formed as described below, so that the layer 103P has the same thickness as that of the first active layer 110. Therefore, the second active layer 111 is formed thicker than the first active layer 110 by the thickness of the lower polysilicon layer 102P. An average crystal grain size of the second active layer 111 is smaller than an average crystal grain size of the first active layer 110, as explained below.

Next, the manufacturing method of the pixel selecting TFT 10 and the driving TFT 85 will be described. First, a buffer layer 101 formed of a silicon nitride film (Si₃N₄) and a silicon oxide film (SiO₂) is formed on the whole surface of the insulating substrate 100 by a CVD method and so on, as shown in FIG. 2A. Then, a first amorphous silicon layer 102 is deposited on the whole surface of the buffer film 101 by a CVD method.

Next, as shown in FIG. 2B, the first amorphous silicon layer 102 in a region to be formed with the pixel selecting TFT 10 is removed by selective etching. The first amorphous silicon layer 102 in a region to be formed with a driving TFT 85 is not etched and remains as it is.

Then, as shown in FIG. 3A, a second amorphous silicon layer 103 is deposited on the whole surface of the insulating substrate 100 by a CVD method. In this process, only the second amorphous silicon layer 103 is formed on the buffer layer 101 in the region to be formed with the pixel selecting TFT 10, while the second amorphous silicon layer 103 is formed on the first amorphous silicon layer 102 in the region to be formed with the driving TFT 85. Then, dehydrogenation of amorphous silicon is performed.

Then, laser irradiation is performed to the first and second amorphous silicon layers 102 and 103 from above the insulating substrate 100, thereby performing laser annealing to these amorphous silicon layers 102 and 103. By this laser annealing, the first and second amorphous silicon layers 102 and 103 are crystallized to become polysilicon layers. At this time, the thickness of the amorphous silicon layer in the region to be formed with the pixel selecting TFT 10 is the same as the thickness of the second amorphous silicon layer 103, while the thickness of the amorphous silicon layer in the region to be formed with the driving TFT 85 is a sum of the thicknesses of the first and second amorphous silicon layers 102 and 103.

Because of the difference of the thicknesses of the amorphous silicon layers, the average crystal grain size of the polysilicon layer in the region to be formed with the driving TFT 85 becomes smaller than the average crystal grain size of the polysilicon layer in the region to be formed with the pixel selecting TFT 110. The crystal grain size also depends on the energy density of the laser in the laser annealing.

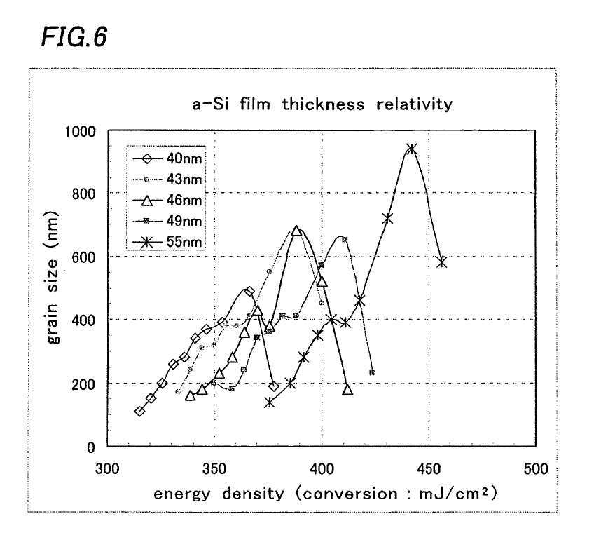

FIG. 6 is a diagram showing a relation between the average crystal grain size after the laser annealing and the laser energy density of the amorphous silicon layers having different film thicknesses (40 nm, 43 nm, 46 nm, 49 nm, 55 nm), when the amorphous silicon layer is crystallized by the laser annealing. As seen in FIG. 6, for each thickness examined, the average crystal grain size after the laser annealing increases with an increase of the laser energy density before reaching a peak grain size, and decreases with the increase of the laser energy density beyond the peak. As the film thickness of the amorphous silicon layer increases, the peak shifts in a right direction (in a increasing direction of the energy density).

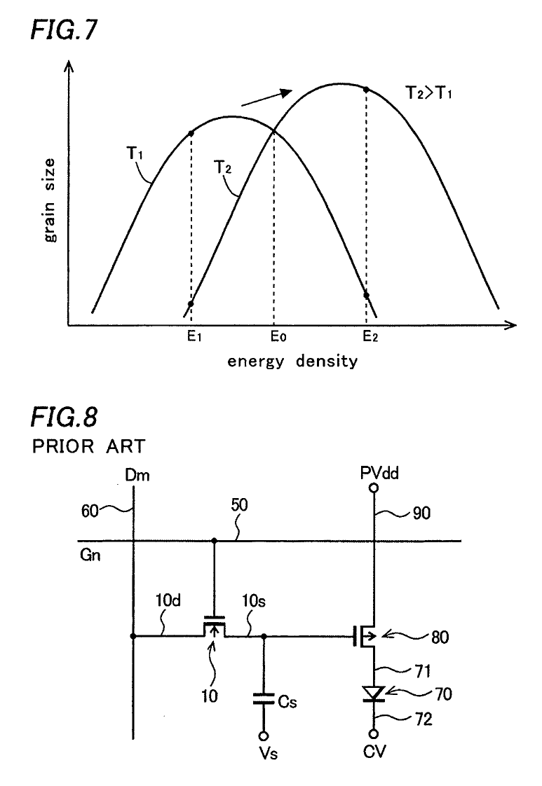

FIG. 7 is a diagram showing schematically the average crystal grain size as a function of the laser energy density. As seen in FIG. 7, a curve of the amorphous silicon layer having a film thickness T1 crosses a curve of the amorphous silicon layer having a film thickness of T2 (T2>T1) at a certain energy density E0. At a low laser energy density E1 (E1<E0), the amorphous silicon layer of larger film thickness T2 has the smaller average crystal grain size than that of the amorphous silicon layer of smaller film thickness T1 after the laser annealing at the same laser energy density E1. On the other hand, at a high laser energy density E2 (E2>E0), the amorphous silicon layer of smaller film thickness T1 has the smaller average crystal grain size than that of the amorphous silicon layer of larger film thickness T2 after the laser annealing at the same laser energy density E2.

Therefore, in this embodiment, by performing the laser irradiation by utilizing the range of the low laser energy density (below E0), the average crystal grain size of the polysilicon layer in the region to be formed with the driving TFT 85 is made smaller than the average crystal grain size of the polysilicon layer in the region to be formed with the pixel selecting TFT 10.

For example, when the thickness of the amorphous silicon layer in the region to be formed with the driving TFT 85 is 49 nm and the thickness of the amorphous silicon layer in the region to be formed with the pixel selecting TFT 10 is 43 nm, by setting the laser energy density at 360 mJ/cm², the average crystal grain size of the polysilicon layer in the region to be formed with the driving TFT 85 after the laser annealing becomes 200 nm or less. On the other hand, the average crystal grain size of the polysilicon layer in the region to be formed with the pixel selecting TFT 10 becomes about 400 nm.

Next, the crystallized first and second amorphous silicon layers 102 and 103 are patterned to form the active layer 110 of the pixel selecting TFT 10 and the active layer 111 of the driving TFT 85, as shown in FIG. 3B. The active layer 111 of the driving TFT 85 is formed of the polysilicon layers 102P and 103P which are the first and second amorphous silicon layers 102 and 103 crystallized by the above laser annealing. The active layer 110 of the pixel selecting TFT 10 is the second polysilicon layer 103 crystallized by the above laser annealing.

Then, the first gate insulating film 104A is formed on the active layer 110 of the pixel selecting TFT 10, and the second gate insulating film 104B is formed on the active layer 111 of the driving TFT 85. Furthermore, the gate electrodes 51 and 52 are formed on the first gate insulating film 104A, and the gate electrode 20 is formed on the second gate insulating film 104B. Then, the interlayer insulating layer 105 is formed on the whole surface.

As described above, the average crystal grain size of the active layer 111 (the polysilicon layer) of the driving TFT 85 is made smaller than the average crystal grain size of the active layer 110 (the polysilicon layer) of the pixel selecting TFT 10, in this embodiment. Therefore, a carrier mobility in the active layer 111 of the driving TFT 85 becomes lower than a carrier mobility in the active layer 110 of the pixel selecting TFT 10.

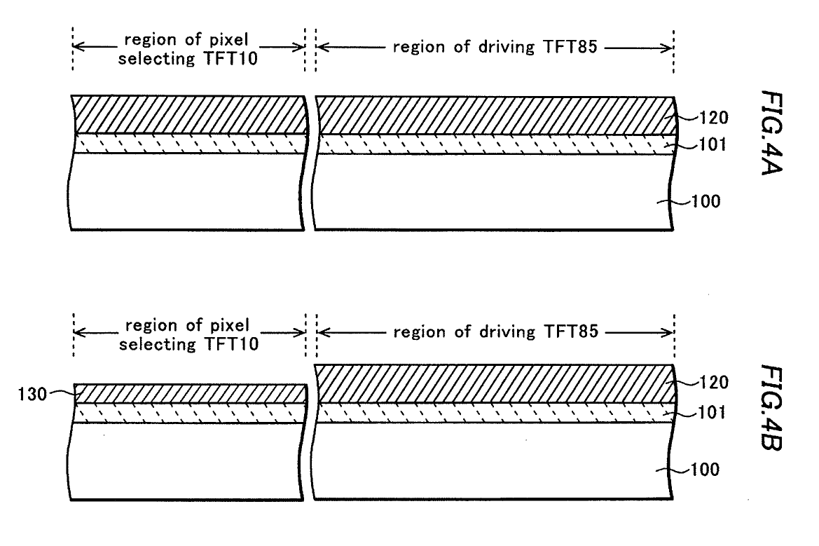

Next, the other manufacturing method of the pixel selecting TFT 10 and the driving TFT 85 will be described. First, a buffer film 101 formed of a silicon nitride film (Si₃N₄) and a silicon oxide film (SiO₂) is formed on the whole surface of a insulating substrate 100 by a CVD method and so on, as shown in FIG. 4A. Then, an amorphous silicon layer 120 is deposited on the whole surface of the buffer film 101 by a CVD method.

Then, as shown in FIG. 4B, the amorphous silicon layer 120 in a region to be formed with the pixel selecting TFT 10 is selectively etched to a predetermined film thickness, leaving the thin amorphous silicon layer 130. The amorphous silicon layer 120 in a region to be formed with the driving TFT 85 is not etched and remains as it is, keeping a larger film thickness.

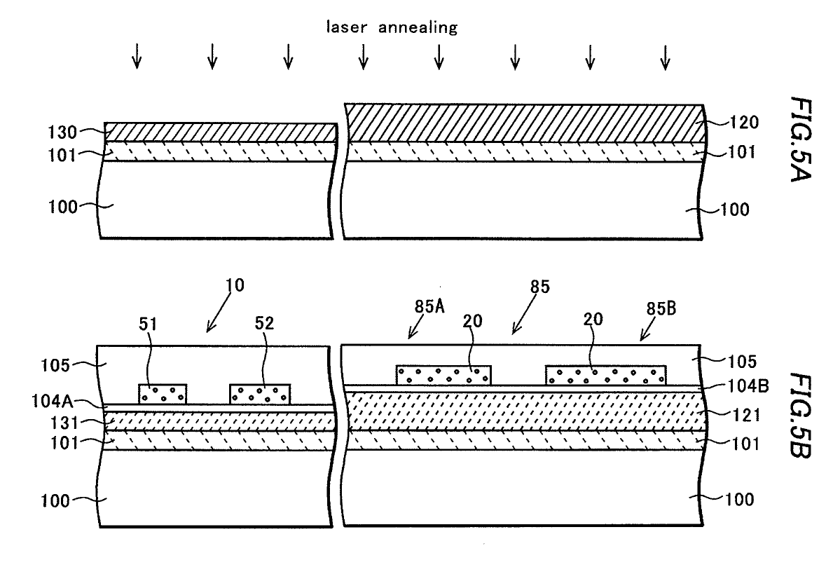

Next, as shown in FIG. 5A, laser annealing is performed on the amorphous silicon layers 120 and 130 having different film thicknesses by irradiating with a laser these amorphous silicon layers 120 and 130 from above the insulating substrate 100. By this laser annealing, the amorphous silicon layers 120 and 130 are crystallized to become polysilicon layers. Because of the difference of the thicknesses of the amorphous silicon layers, the average crystal grain size of the polysilicon layer in the region for the driving TFT 85 becomes smaller than the average crystal grain size of the polysilicon layer in the region for the pixel selecting TFT 110.

The crystallized amorphous silicon layers 120 and 130 are patterned to form an active layer 131 of the pixel selecting TFT 10 and an active layer 121 of the driving TFT 85, as shown in FIG. 5B. Then, a first gate insulating film 104A is formed on the active layer 131 of the pixel selecting TFT 10, and a second gate insulating film 104B is formed on the active layer 121 of the driving TFT 85. Furthermore, gate electrodes 51 and 52 are formed on the first gate insulating film 104A, and the gate electrode 20 is formed on the second gate insulating film 104B. An interlayer insulating layer 105 is formed on the whole surface.

The other embodiment of the invention will be described next. This embodiment utilizes the higher range of the laser energy density E2 (E2>E0) in FIG. 7. That is, as described above, in this high laser energy density range, the average crystal grain size of the amorphous silicon layer having a smaller film thickness T1 is smaller than the amorphous silicon layer having a larger film thickness T2.

Therefore, the amorphous silicon layer to be the active layer of the pixel selecting TFT 10 is made thick, and the amorphous silicon layer to be the active layer of the driving TFT 85 is made thin. Then, the laser annealing is performed to these amorphous silicon layers by laser irradiation at the same laser energy density E2 (E2>E0). The other structure is the same as that of the described embodiment, and the manufacturing method described in the above embodiment can be used in this embodiment. That is, for forming a thick amorphous silicon layer to be the active layer of the pixel selecting TFT 10 and a thin amorphous silicon layer to be the active layer of the driving TFT 85, the amorphous silicon layer is formed on the whole surface first, the amorphous silicon layer in the region for the driving TFT 85 is removed, and another amorphous silicon layer is formed thereon. Alternatively, the amorphous silicon layer is formed on the whole surface first, and the amorphous silicon layer in the region for the driving TFT 85 is etched to a predetermined film thickness.

1. A display device comprising:
a plurality of pixels:
an emissive element provided in each of the pixels and emitting light by receiving a current;
a pixel selecting transistor provided in each of the pixels and selecting a corresponding pixel in response to a gate signal, the pixel selecting transistor comprising a first active semiconductor layer, a first gate insulating layer formed on the first active semiconductor layer and a first gate electrode formed on the first gate insulating layer; and
a driving transistor provided in each of the pixels and supplying the current to a corresponding emissive element in response to a display signal supplied through a corresponding pixel selecting transistor, the driving transistor comprising a second active semiconductor layer, a second gate insulating layer formed on the second active semiconductor layer and a second gate electrode formed on the second gate insulating layer,
wherein a film thickness of the first active semiconductor layer is different from a film thickness of the second active semiconductor layer, and an average crystal grain size of the first active semiconductor layer is larger than an average crystal grain size of the second active semiconductor layer.

2. The display device of claim 1, wherein the film thickness of the first active semiconductor layer is smaller than the film thickness of the second active semiconductor layer.

3. The display device of claim 1, wherein the film thickness of the first active semiconductor layer is larger than the film thickness of the second active semiconductor layer.

4. The display device of claim 1, wherein the first active semiconductor layer and the second active semiconductor layer are made of silicon.

5. The display device of claim 4, wherein the average crystal grain size of the second active semiconductor layer is 200 nm or less.

6. The display device of claim 1, wherein the emissive element comprises an organic electroluminescent element.

7. A method of manufacturing a display device comprising an emissive element, comprising:
depositing a first amorphous silicon layer on a surface of an insulating substrate;
removing the first amorphous silicon layer from a first region of the insulating substrate so as to leave the first amorphous silicon layer in a second region of the insulating substrate;
depositing a second amorphous silicon layer on the first region from which the first amorphous silicon layer is removed and the second region having the first amorphous silicon layer thereon;
irradiating the first and second amorphous silicon layers with laser of a predetermined energy density so as to crystallize the first and second amorphous silicon layers;
forming a pixel selection transistor in the first region so that part of the second amorphous silicon layer of the first region forms an active layer of the pixel selection transistor; and
forming a transistor driving the emissive element in the second region so that parts of the first and second amorphous silicon layers form an active layer of the driving transistor.

8. The method of claim 7, wherein the energy density of the laser is set so that an average crystal grain size of the first active layer is larger than an average crystal grain size of the second active layer.

9. The method of claim 8, wherein the energy density of the laser is set so that the crystal grain size of the second active layer becomes 200 nm or less.

10. The method of claim 7, wherein the emissive element comprises an organic electroluminescent element.

11. A method of manufacturing a display device comprising an emissive element, comprising:
depositing an amorphous silicon layer on a surface of an insulating substrate;
etching the amorphous silicon layer so that a thickness of the amorphous silicon layer is reduced to a predetermined thickness at a first region of the insulating substrate and the amorphous silicon layer is left unetched in a second region of the insulating substrate;
irradiating the etched amorphous silicon layer in the first region and the unetched amorphous silicon layer in the second region with laser of a predetermined energy density so as to crystallize the amorphous silicon layer;
forming a pixel selection transistor in the first region so that part of the etched amorphous silicon layer forms an active layer of the pixel selection transistor; and
forming a transistor driving the emissive element in the second region so that part of the unetched amorphous silicon layer form an active layer of the driving transistor.

12. The method of claim 11, wherein the energy density of the laser is set so that an average crystal grain size of the first active layer is larger than an average crystal grain size of the second active layer.

13. The manufacturing method of the display device of claim 12, wherein the energy density of the laser is set so that the crystal grain size of the second active layer becomes 200 nm or less.

14. The manufacturing method of the display device of claim 11, wherein the emissive element comprises an organic electroluminescent element.

15. A method of manufacturing a display device comprising an emissive element, comprising:
forming a first amorphous silicon layer in a first region of an insulating substrate;
forming a second amorphous silicon layer in a second region of an insulating substrate so as to have a thickness different from a thickness of the first amorphous silicon layer;
irradiating the first and second amorphous silicon layers with laser of a predetermined energy density so as to crystallize the first and second amorphous silicon layers;
forming a pixel selection transistor in the first region so that part of the first amorphous silicon layer forms an active layer of the pixel selection transistor; and
forming a transistor driving the emissive element in the second region so that part of the second amorphous silicon layer forms an active layer of the driving transistor,
wherein the energy density of the laser is set so that an average crystal grain size of the first active layer is larger than an average crystal grain size of the second active layer.

16. The method of claim 15, wherein the thickness of the first amorphous silicon layer is larger than the thickness of the second amorphous silicon layer.

17. The method of claim 15, wherein the thickness of the first amorphous silicon layer is smaller than the thickness of the second amorphous silicon layer.

18. The method of claim 15, wherein the energy density of the laser is set so that the crystal grain size of the second active layer becomes 200 nm or less.

19. The method of claim 15, wherein the emissive element comprises an organic electroluminescent element.
